(19) United States
(12) Patent Application Publication
(10) Pub. No.: US 2026/0079675 A1
(43) Pub. Date: Mar. 19, 2026

(54) RAW DESIGN SYSTEM AND METHOD

(71) Applicant: DevRev, Inc., Palo Alto, CA (US)

(72) Inventors: Dejan Mesar, Sežana (SI); Shubham Gandhi, Jaipur (IN)

(73) Assignee: DevRev, Inc., Palo Alto, CA (US)

(21) Appl. No.: 19/094,787

(22) Filed: Mar. 28, 2025

(30) Foreign Application Priority Data
Sep. 17, 2024 (IN) 202441070277

(51) Int. Cl. G06F 8/20

(52) U.S. Cl. CPC G06F 8/20

(57) ABSTRACT

A raw design system configured to enable users to build software applications is provided. It may be noted that the software application comprises a user interface. The raw design system comprises a plurality of raw components configured to define a structure of a plurality of elements. The plurality of elements is configured to provide a corresponding plurality of functions and is embedded in the user interface. The raw design system further comprises at least one composable theme coupled to each raw component and configured to enable the user to define a theme to the plurality of elements embedded in the user interface.

### RELATED APPLICATION DATA

This application claims priority to, and the benefit of, Indian Patent Application No. 202441070277 filed on Sep. 17, 2024. The entire disclosure of the above application is expressly incorporated by reference herein.

### BACKGROUND

The invention generally relates to the field of application design systems and more particularly, to a system and method for building software applications using a raw design system.

Typically, software applications built for web browsers and mobile phones are designed to have multiple user interfaces that allow a user to interact with the application. These user interfaces typically have several unique elements embedded within to allow the user to interactively use the application.

These unique elements are designed in a way to help users to have a consistent experience while using the software applications via a web browser or a mobile application. In most cases, these unique elements are usually implemented using a specific software component that define the style, structure, and the functionality of the element.

Designers typically use existing user interface libraries to design the various components that define the unique elements. However, these libraries provide the user with very limited styling capabilities. Design systems then require hacks or tight integration of styles directly into the components thus making components tightly coupled with the application itself.

In addition, the components used to design these unique elements are not reusable across various user interfaces within the same software application and thus designers find it cumbersome and inefficient to work with the limited abilities of the components. Also, designers usually are required to repeatedly define a uniform theme across the components to maintain a consistent look across the software application.

Therefore, there is a software application design system that allow a designer to use reusable components across user interfaces while implemented predefined themes across the components as in when needed. By enabling the user to reuse components and themes across the user interfaces, the design system is more efficient and easier to use.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a raw design system configured to enable users to build software applications is provided. It may be noted that the software application comprises a user interface. The raw design system comprises a plurality of raw components configured to define a structure of a plurality of elements. The plurality of elements is configured to provide a corresponding plurality of functions and is embedded in the user interface. The raw design system further comprises at least one composable theme coupled to each raw component and configured to enable the user to define a theme to the plurality of elements embedded in the user interface.

In another embodiment, a design method configured to enable users to build software applications. The software applications comprise one or more user interfaces. The design method comprises defining a plurality of raw components for a plurality of elements embedded in each user interface. The plurality of elements is configured to provide a corresponding plurality of functions. The method further includes defining at least one composable theme for each raw component; wherein the raw components and the at least one theme is defined independently.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram of an embodiment of a software application, implemented according to aspects of the present technique;

FIG. 2 is a block diagram of an embodiment of a raw design system implemented according to aspects of the present technique;

FIG. 3 is a block diagram of an embodiment of a raw component, implemented according to aspects of the present technique;

FIG. 4 is a flow chart describing a design method implemented for designing a software application, according to the present technique; and

FIG. 5 is a block diagram of an embodiment of a computing device in which the modules of the raw design system described herein are implemented.

### DETAILED DESCRIPTION OF EXAMPLE EMBODIMENTS

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figures. It should also be noted that in some alternative implementations, the functions/acts/steps noted may occur out of the order noted in the figures. For example, two figures shown in succession may, in fact, be executed substantially concurrently or may sometimes be executed in the reverse order, depending upon the functionality/acts involved.

Spatial and functional relationships between elements (for example, between modules) are described using various terms, including “connected,” “engaged,” “interfaced,” and “coupled. ” Unless explicitly described as being “direct,” when a relationship between first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Example embodiments of the present invention provide systems and methods for designing software application. As will be known to one skilled in the art, the software application is adaptable for use as web applications and/or mobile applications. For clarity and conciseness, the following examples are described with reference to web applications however it should be apparent to those skilled in the art that the techniques described herein may be used for implementation of mobile applications as well. The software application is described in further detail below.

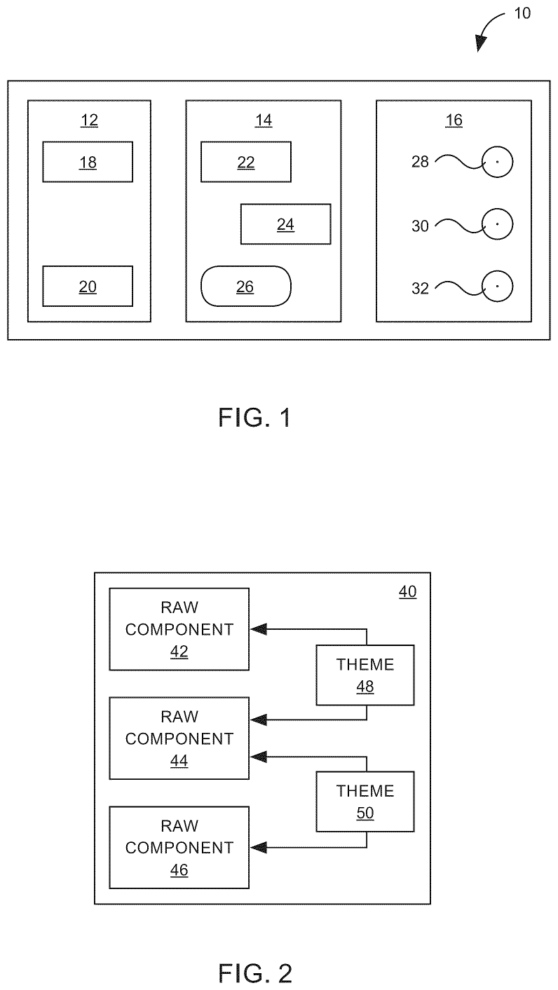

FIG. 1 is a block diagram of an embodiment of a software application implemented according to aspects of the present technique. In the illustrated embodiment, the software application is designed as a web application. The software application comprises multiple user interfaces with each user interface including various elements. Each block is described in further detail below.

User Interface (UI) 12, 14 and 16 are configured to enable a user to interact with the software application 10. Examples of software applications include chat applications, e-commerce applications, media applications and the like. UI 12, 14 and 16 are designed to provide information to the user while navigating the software application. Each user interface includes several elements that allow for efficient and effective interaction.

Elements 18 and 20 are embedded in user interface 12. In one embodiment, elements 18 and 20 are text boxes that allow the user to input data to the software application in a text format. For example, elements 18 and 20 may include sign in and password field where the user provides the required information. In one embodiment, upon entering information via elements 18 and 20, the application moves to user interface 14.

Elements 22, 24 and 28 are embedded in user interface 14. In one embodiment, elements 22 and 24 are rectangular tabs and element 26 is a circular tab. In one embodiment, the tabs provide the user with information regarding different actions. One such action takes the user to user interface 16.

Elements 28, 30 and 32 are embedded in user interface 16. In one embodiment, elements 28, 30 and 32 are buttons that enable the user to provide binary responses to certain queries. Examples of binary responses include inputs in true/false, yes/no, agree/disagree format. As can be seen for above, the software application includes several user interfaces and each user interface include one or more elements. In order to design the software application, a raw design system is used which is described in further detail below.

FIG. 2 is a block diagram of an embodiment of a raw design system implemented according to aspects of the present invention. Raw design system 40 is configured to enable software designers to build software applications with one or more user interface, as describe for example, in FIG. 1. Raw design system 40 comprises raw components 42, 44 and 46 and themes 48 and 50. Each block is described in further detail below.

Raw components 42, 44 and 46 are configured to define a structure of a plurality of elements embedded in a software application. For example, the raw components 42, 44 and 46 is configured to define a functionality of elements embedded in user interfaces 12, 14 and 16 of software application 10.

Theme 48 is configured to be injected into raw component 42 and 44 and theme 50 is configured to be injected into raw component 44 and 46. Themes 48 and 50 are configured to enable the software designer to define a theme to the plurality of elements embedded in the user interface.

As can be seen from FIG. 2, the raw design system decouples the raw components from the themes and enables the user to inject various themes to various components used to define the plurality of elements. Thus, the raw components are reusable and can be used across user interfaces with the themes applied to them as desired. In addition, themes 48 and 50 are reusable across raw components 42, 44 and 46. It may also be noted that the raw components may be reused while design separate software applications, as well. The manner in which the raw component operates is described in further detail below.

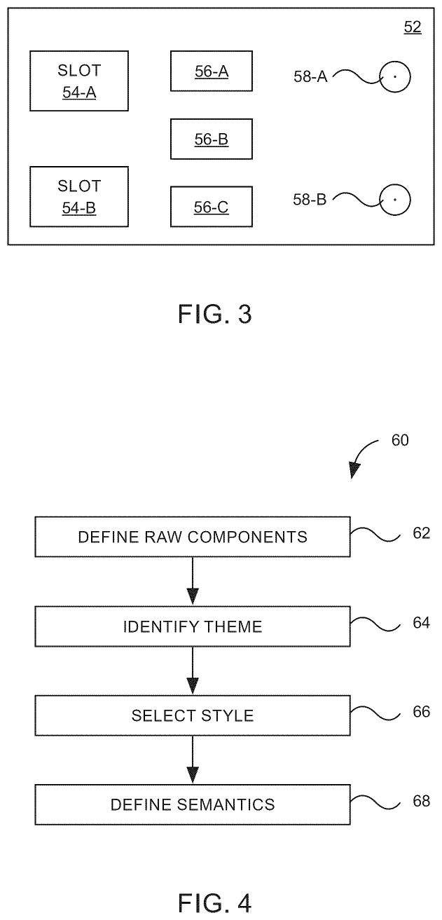

FIG. 3 is a block diagram of an embodiment of a raw component, implemented according to aspects of the present technique. Raw component 52 comprises slots, variants and modifiers as shown. Each block is described in further detail below.

Slots 54-A and 54-B are configured to enable the user to apply a predefined style to the plurality of elements. In one embodiment, the predefined style is defined using themes such as theme 48 and 50 described in FIG. 2.

Variants 56-A through 56-C are configured to enable the user to define the semantics of the plurality of elements. In one embodiment, the variants can be used to define one or more properties of an element embedded in the user interface. Examples of properties include orientation, type, shape, size, etc.

Modifiers 58-A and 58-B are configured to enable the user to define a binary attribute to the plurality of elements. Examples of binary attributes include enable or disable, required or optional, and the like. In one embodiment, modifiers 58-A and 58-B is used to add radio buttons on the user interface. The manner in which the raw components are themes are reused across interfaces is described in further detail below.

FIG. 4 is a flow chart describing a design method implemented for designing a software application, according to the present technique. The design method 60 described herein enable users to build software applications that are adapted for use as web application and/or mobile applications. The software application comprises a user interface and the design method specifically uses reusable components and composable themes to design the user interface. Each step of design method is described below.

At step 62, a plurality of raw components is defined for use in the design of the software application. Specifically, the defined raw components correspond to elements embedded on one or more user interfaces. It may be noted that the raw components are reusable across user interfaces.

At step 64, at least one composable theme is defined for each raw component. In one embodiment, each raw component is injected with the theme as required. Again, it may be noted that the one theme may be injected into multiple raw components.

At step 66, a predefined style is selected via the theme. In one embodiment, the predefined style determines an aesthetic of the plurality of elements embedded in the user interfaces. The predefined style is defined using the at least one composable theme as described in step 64.

At step 68, the semantics of the plurality of elements is defined by the raw components. Further, for elements in the user interface that are binary in nature, a binary attribute is defined in the raw components corresponding to those elements.

Thus, it is seen that the raw components are interchangeably reused across the user interfaces and the themes can be easily injected into the raw components as and when needed. This removes the need to rewrite components with specific themes. In addition, the raw design system decouples raw component from themes which ensures quick design and development of software applications as components are style agnostic. Further, software applications may include sections where different themes are used as themes may be injected into the raw components. Further the raw components may be reused to design various software application thus making it reusable.

The various actions, acts, blocks, steps, or the like as described above may be performed in the order presented, in a different order or simultaneously. Further, in some embodiments, some of the actions, acts, blocks, steps, or the like may be omitted, added, modified, skipped, or the like without departing from the scope of the invention.

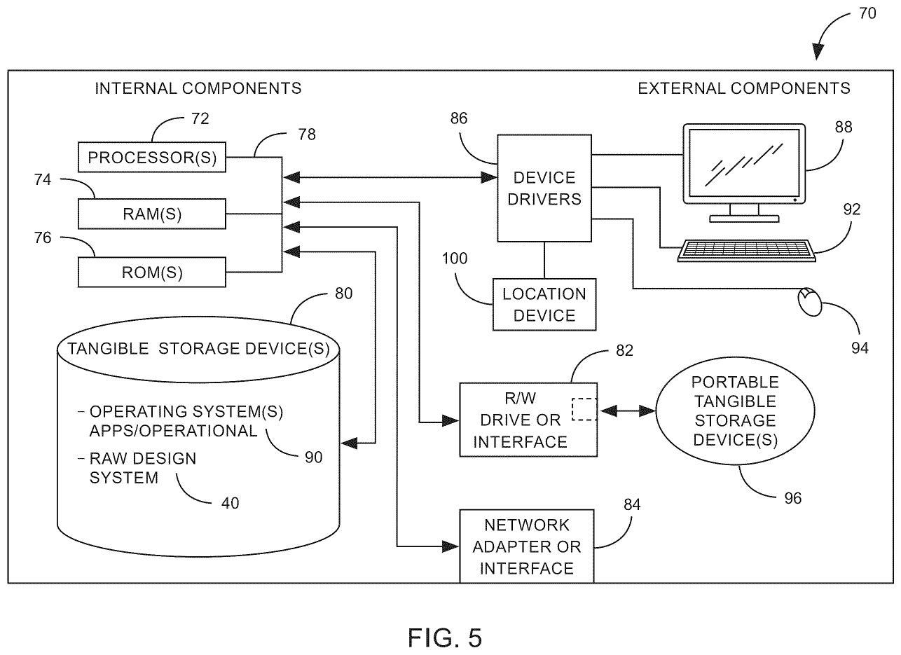

The raw design system 40 described herein is implemented using a computing device such as computing device 70 is described below in FIG. 5. The computing device 70 includes one or more processor(s) 72, one or more computer-readable RAMs 74 and one or more computer-readable ROMs 76 on one or more buses 78. Further, computing device 70 includes a tangible storage device 80 that may include raw design system 40 for designing user interfaces for a software application. The various modules of the raw design system 40 may be stored in the tangible storage device 80. Both, the operating systems 90 and the system 10 are executed by the one or more processor(s) 72 via one or more respective RAMs 74 (which typically include cache memory). The execution of the operating systems 90 and/or the system 10 by the one or more processor(s) configures the one or more processor(s) as a special purpose processor configured to carry out the functionalities of the operation systems) and/or the system 10 as described above.

Examples of the tangible storage device include semiconductor storage devices such as ROM, EPROM, flash memory or any other computer-readable tangible storage device that may store a computer program and digital information.

Computing device 70 also includes a R/W drive or interface 82 to read from and write to one or more portable computer-readable tangible storage devices 96 such as a CD-ROM, DVD, memory stick or semiconductor storage device. Further, network adapters or interfaces 84 such as a TCP/IP adapter cards, wireless Wi-Fi interface cards, or 3G or 4G wireless interface cards or other wired or wireless communication links are also included in computing device.

In one example embodiment, the raw design system 40 may be stored in the tangible storage device and may be downloaded from an external computer via a network (for example, the Internet, a local area network or other, wide area network) and network adapter or interface.

Computing device 70 further includes device drivers 86 to interface with input and output devices. The input and output devices may include a computer display monitor 88, a keyboard 92, a keypad, a touch screen, a computer mouse 94, and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification.

It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other example features of example embodiments may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer-device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The computer readable medium or storage medium may be a built-in medium installed inside a computer device main body or a removable medium arranged so that it may be separated from the computer device main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

1. A raw design system configured to enable users to build software applications, wherein the software application comprises a user interface, the raw design system comprising:
a plurality of raw components configured to define a structure of a plurality of elements; wherein the plurality of elements is configured to provide a corresponding plurality of functions and is embedded in the user interface; and
at least one composable theme coupled to each raw component and configured to enable the user to define a theme to the plurality of elements embedded in the user interface.

2. The raw design system of claim 1, wherein each raw component comprises at least one slot configured to enable the user to apply a predefined style to the plurality of elements; wherein the predefined style is defined using the at least one composable theme.

3. The raw design system of claim 2, wherein each raw components comprises at least one variant configured to enable the user to define the semantics of the plurality of elements.

4. The raw design system of claim 1, wherein each variant further comprises a modifier configured to enable the user to define a binary attribute to the plurality of elements.

5. The raw design system of claim 1, wherein the plurality of raw components is reusable across a set of user interfaces designed within the software applications.

6. The raw design system of claim 1, wherein the at least one composable theme is reusable across the plurality of raw components.

7. The raw design system of claim 1, wherein the software application is adaptable for use as a web application or a mobile application.

8. A design method configured to enable users to build software applications, wherein the software applications comprise one or more user interfaces, the design method comprising:
defining a plurality of raw components for a plurality of elements embedded in each user interface; wherein the plurality of raw components is defined to provide a corresponding plurality of functions to the plurality of elements; and
defining at least one composable theme for each raw component; wherein the raw components and the at least one theme is defined independently.

9. The design method of claim 8, further comprising applying a predefined style to the plurality of elements; wherein the predefined style is defined using the at least one composable theme.

10. The design method of claim 8, further comprising defining the semantics of the plurality of elements.

11. The design method of claim 8, defining a binary attribute to the plurality of elements.

12. The design method of claim 8, wherein the plurality of raw components is reusable across a set of user interfaces designed within the software applications.

13. The design method of claim 8, wherein the composable theme is reusable across more than one raw component.

14. The design method of claim 8, wherein the software application is adaptable for use as a web application or a mobile application.
